(19) United States
(12) Patent Application Publication
(10) Pub. No.: US 2018/0239165 A1
(43) Pub. Date: Aug. 23, 2018

(54) CUSTOM FIT NOSE PADS FOR SPECTACLE FRAMES

(71) Applicant: General Scientific Corp., Ann Arbor, MI (US)

(72) Inventor: Byung J. Chang, Ann Arbor, MI (US)

(21) Appl. No.: 15/438,167

(22) Filed: Feb. 21, 2017

(51) Int. Cl. G02C 5/12; G02C 5/00; G02C 7/08; G02C 7/10; G02C 5/02

(52) U.S. Cl. CPC G02C 5/122; G02C 5/008; G02C 7/088; G02C 2202/16; G02C 5/02; G02C 5/126; G02C 2200/10; G02C 7/10

(57) ABSTRACT

An adjustable nosepiece assembly for a set of eyeglass frames having a bridge portion between lenses comprises a nosepiece component configured for coupling to the bridge portion of the eyeglass frames, the nosepiece component being adapted for resting on a wearer's nose when wearing the eyeglass frames, and a plurality of spacer components configured for placement between the nosepiece component and the bridge portion of the eyeglass frames to adjust the distance between the nosepiece component and the bridge portion of the eyeglass frames. The nosepiece component may be an inverted-V shape with two angled, bendable leg portions. The spacer components may facilitate adjustment of the distance between the nosepiece component and the bridge portion of the eyeglass frames in a range of 1 mm to 1.5 cm or more.

### FIELD OF THE INVENTION

This invention relates to spectacle frames and, more particularly, to spectacle frames with adjustable nose pads.

### BACKGROUND OF THE INVENTION

There are basically two types of loupe assemblies for surgical, medical and dental professionals: (1) the flip-up type, which provides for multiple degrees of adjustment freedom, and (2) the through-the-lens (TTL) types, wherein separate loupes are cemented into the eyeglass lenses. With flip-up styles, adjustments such as interpupillary distance and declination angle are readily provided. With TTL loupes, however, adjustments of interpupillary distance and declination angle require more careful consideration.

Another aspect of TTL loupe design involves the distance between the oculars and the wearer's eyes. FIG. 1 illustrates a generic TTL configuration seen from the side, including eyeglass lens 102 and TTL ocular 104. The ocular 104 is cemented in the lens 102 in the region of 106, resulting in a distance “d” between the ocular device 104 and the eye of the wearer.

FIG. 2 is a drawing that shows a full set of eyeglass frames with non-adjustable nose pads. Particularly with advances in improved declination angle to improve posture, this distance “d” in FIG. 1 may be too small for certain facial features, resulting in interference with the person's eyelashes and/or a reduction in peripheral vision. In particular, the eyelashes of the wearer may touch the oculars, peripheral vision may be blocked by the ocular, and/or fogging of carrier lenses may occur due to limited ventilation.

The need remains, therefore, for a TTL loupe product with a nose bridge that can be adjusted in the field, preferably with a mechanism that does not interfere with ornamental appearance.

### SUMMARY OF THE INVENTION

This invention alleviates problems associated with prior-art devices by providing an adjustable nosepiece assembly for a set of eyeglass frames having a bridge portion between lenses. The assembly comprises a nosepiece component configured for coupling to the bridge portion of the eyeglass frames, the nosepiece component being adapted for resting on a wearer's nose when wearing the eyeglass frames, and a plurality of spacer components configured for placement between the nosepiece component and the bridge portion of the eyeglass frames to adjust the distance between the nosepiece component and the bridge portion of the eyeglass frames.

In the preferred embodiment the nosepiece component is an inverted-V shape with two angled leg portions extending downwardly and away from an upper portion coupled to the bridge portion of the eyeglass frames through one or more of the spacer components. The two angled leg portions may be formed with a flexible, pliable and/or soft material over a bendable wire frame or scaffold enabling the leg portions to be bent for adjustment purposes.

The spacer components may facilitate adjustment of the distance between the nosepiece component and the bridge portion of the eyeglass frames in a range of 1 mm to 1.5 cm or more. The lenses of the eyeglass frames may include through-the-lens oculars or loupes, in which case the placement of the spacer component(s) between the nosepiece component and the bridge portion of the eyeglass frames may be used to adjust the distance between the TTL loupes and facial features of a wearer such as the cheeks, eyelashes, and so forth.

A method of custom-fitting a nose pad in accordance with the invention comprises the steps of:

providing a set of eyeglass frames including an upper bridge portion between lens portions, each lens portion including a through-the-lens (TTL) loupe;

providing a nosepiece component configured for coupling to the bridge portion of the eyeglass frames;

providing a plurality of spacer components, each with a different thickness;

placing the eyeglass frames on a wearer, and observing the distance between the TTL loupes and facial features of the wearer; and

installing one or more of the spacer components between the nosepiece component and the bridge portion of the eyeglass frames to achieve a desired distance between the TTL loupes and facial features of the wearer.

### BRIEF DESCRIPTION OF THE DRAWINGS

FIG. 1 is a drawing that shows how prior-art loupes or oculars often need adjustment for comfort and/or use;

FIG. 2 is a drawing that shows prior-art eyeglass frames with non-adjustable nose pads;

FIG. 3 is a drawing that shows eyeglass frames with adjustable nose pads constructed in accordance with the invention;

FIG. 4 is a detail drawing that illustrates component parts of the configuration of FIG. 3;

FIG. 5 is a drawing that shows how the invention better accommodates prescription lenses, color, x-ray of other filters in front of eyeglass lenses; and

FIG. 6 illustrates an adjustable nose pad structure with a recess for receiving drop-in filters.

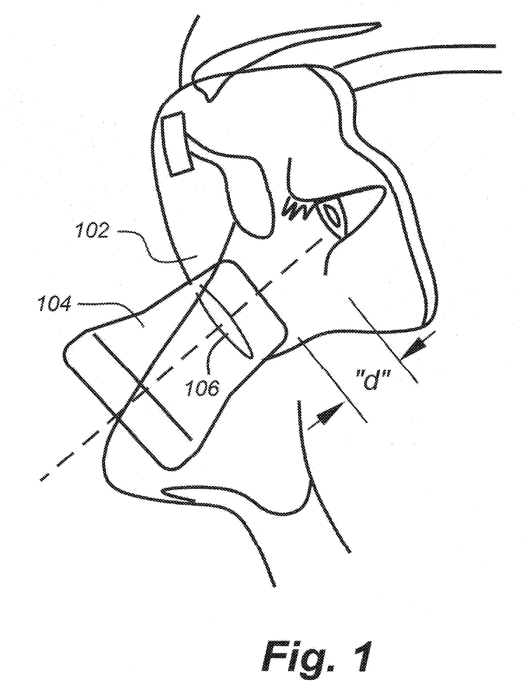

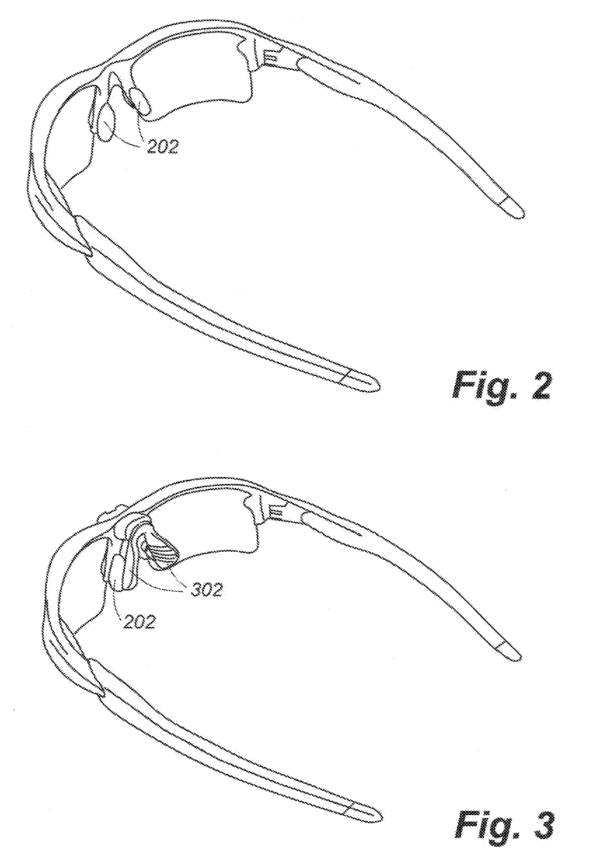

### DETAILED DESCRIPTION OF THE PREFERRED EMBODIMENTS

This invention improves upon the prior art by providing spectacle frame nose pads that are truly adjustable, thereby facilitating fit and comfort for a wide variety of uses. In particular, when used with eyeglass frames including through-the-lens (TTL) loupes, the invention facilitates a graduated adjustment of the distance. Note that although the Figures show the invention mounted on particular set of eyeglass frames, it should be understood that the invention is applicable to any type of frames, with or without loupes, TTL or otherwise.

FIG. 3 is a drawing that shows eyeglass frames with adjustable nose pads 302 constructed in accordance with the invention. Note that the existing nose pads 202 provided with the eyeglass frames may or may not be removed to accommodate the invention. If left in place a double nose pad arrangement is provided for greater support, stability, and weight reduction. This is especially advantageous when using higher magnification loupes.

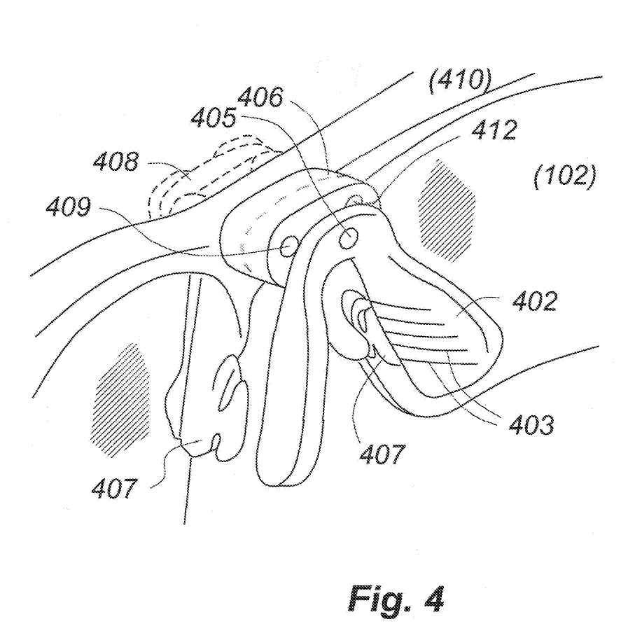

FIG. 4 is a drawing that illustrates the basic components of the inventive structure. As shown in the Figure, lenses 102 descend from an upper support 410 that includes a bridge portion between the lenses. In accordance with the invention, a nose piece 402 is coupled to the bridge portion through at least one spacer component 406 used to adjust the distance between the nose piece and the bridge portion of the eyeglass frames.

The spacer components are preferably be constructed of a hard and/or rigid plastic material, held in position to the bridge portion of the frames with glue or fasteners. In the preferred embodiment, the spacers may be attached to the bridge portion of the frames through opposing fasteners 409, 412, which may or may not protrude all the way through the bridge portion. If longer screws or bolts are used, the added length may be used to engage with optional structures such as 408 to the mounting of other devices such as headlamps, video cameras, and so forth.

A plurality of different spacer components may be provided to allow for adjustments in the range of 1 mm to 1.5 cm or more. Multiple spacers may also be stacked if necessary to achieve a desired spacing, as indicated with the broken line in FIG. 4. Items 407 indicate the barbed structures where the nose pads supplied with the frames were removed, if desired.

Nose piece 402 preferably comprises an inverted V shape with ribs 403 or other texture to reduce slippage. This component is preferably made by overmolding a soft, pliable polymeric material such as silicone over a metal wire scaffold allowing the legs of the component to be bent apart and toward one another to assume a comfortable fit. The nose piece is preferably attached to the spacer component with a more central screw or other fastener 405.

In accordance with the invention, the space between the oculars and the eyes can be optimized. As such, most fitting problems can be eliminated. The best performing loupes are the ones that fit the best, both with how the frames fit the face, and how the oculars are placed relative to the eyes. When these characteristics are optimized, the clinician has the clearest and sharpest view of their target, with the added bonus of a comfortable, all-day fit. The adjustable nose pad design allows for greater adjustability and fine tuning, so the clinician can truly customize their fit and comfort, and get the most out of their loupes.

Thanks to the invention, the clinician will enjoy the optimum space between their eyes and the oculars, which provides the best balance between optical field and peripheral vision. Clinicians with long eyelashes will not experience the uncomfortable and annoying touching of their eyelashes to their oculars. The wider opening between the face and the oculars provides better ventilation between the clinician's face and loupes, and the problem of fogging and sweating is greatly reduced. Sports frames, which can be difficult to fit to some people, are now easily adjustable for anyone to wear.

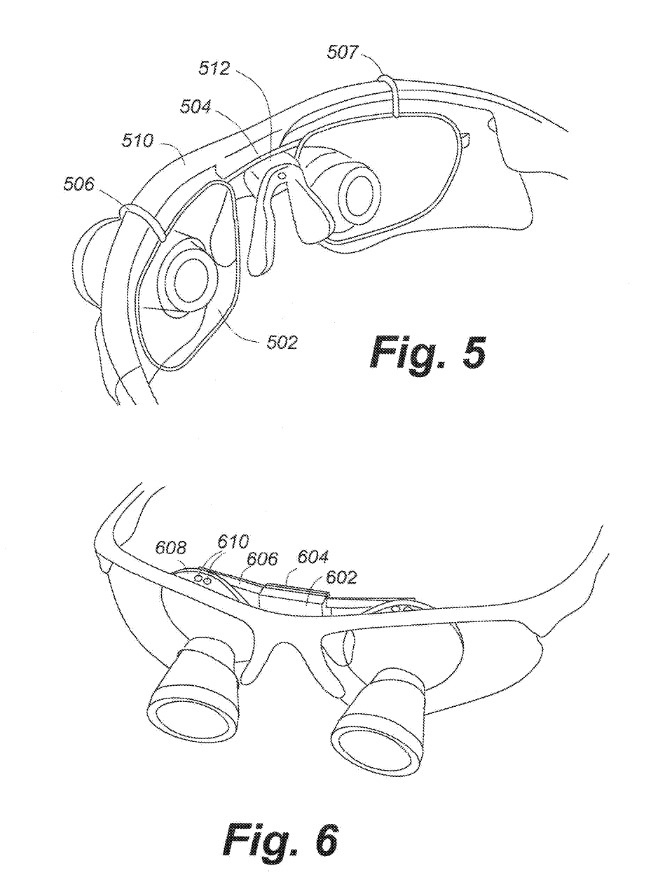

The wider opening between the face and the oculars provides additional advantages. In particular, the wider spacing enables additional lenses to be positioned between the oculars and the eyes of the wearer. FIG. 5 is a drawing that shows how the invention accommodates inside-mounted filters 502 with rim hooks 506, 507 that hang on the top edge of frames 510. The rimmed lenses may attach via connector 504 disposed above the spacer component(s) 512.

FIG. 6 illustrates an adjustable nose pad structure 602 with a recess 604 for receiving drop-in filters 608 interconnected with a bar 606 attached to the lenses 608 with fasteners 610. In this embodiment, the groove or recess 604 is wide enough to receive the interconnecting bar 606. In both of the embodiments of FIGS. 5, 6, the lenses 502, 608 may be of any type, including prescription lenses, color, x-ray or other filters.

1. An adjustable nosepiece assembly for a set of eyeglass frames having a bridge portion between lenses, comprising:
a nosepiece component configured for coupling to the bridge portion of the eyeglass frames, the nosepiece component being adapted for resting on a wearer's nose when wearing the eyeglass frames; and
one or more spacer components configured for placement between the nosepiece component and the bridge portion of the eyeglass frames to adjust the distance between the nosepiece component and the bridge portion of the eyeglass frames.

2. The assembly of claim 1, wherein the nosepiece component is an inverted-V shape with two angled leg portions extending downwardly and away from an upper portion coupled to the bridge portion of the eyeglass frames through one or more of the spacer components.

3. The assembly of claim 1, wherein the nosepiece component is an inverted-V shape with two angled leg portions formed with a flexible material over a bendable wire frame or scaffold enabling the leg portions to be bent for adjustment purposes.

4. The assembly of claim 1, wherein the spacer components facilitate adjustment of the distance between the nosepiece component and the bridge portion of the eyeglass frames in a range of 1 mm to 1.5 cm or more.

5. The assembly of claim 1, further including a set of eyeglass frames with lenses including through-the-lens oculars or loupes.

6. An adjustable nosepiece assembly for a set of eyeglass frames having a bridge portion between lenses, each lens including a through-the-lens (TTL) loupe, the assembly comprising:
a nosepiece component configured for coupling to the bridge portion of the eyeglass frames, the nosepiece component being adapted for resting on a wearer's nose when wearing the eyeglass frames; and
one or more spacer components configured for placement between the nosepiece component and the bridge portion of the eyeglass frames to adjust the distance between the TTL loupes and facial features of a wearer.

7. The assembly of claim 6, wherein the nosepiece component is an inverted-V shape with two angled leg portions extending downwardly and away from an upper portion coupled to the bridge portion of the eyeglass frames through one or more of the spacer components.

8. The assembly of claim 6, wherein the nosepiece component is an inverted-V shape with two angled leg portions formed with a flexible material over a bendable wire frame or scaffold enabling the leg portions to be bent for adjustment purposes.

9. The assembly of claim 6, wherein the spacer components facilitate adjustment of the distance in a range of 1 mm to 1.5 cm or more.

10. The assembly of claim 6, further including a drop-in optical component between the oculars and the eyes of a wearer.

11. The assembly of claim 10, wherein the drop-in optical component comprises prescription lenses or filters.

12. The assembly of claim 10, wherein the drop-in optical component includes hooks that rest on the eyeglass frames.

13. The assembly of claim 10, wherein the drop-in optical component includes a central bar received by a recess or groove ion the top of a spacer component.

14. A method of custom-fitting a nose pad, comprising:
providing a set of eyeglass frames including an upper bridge portion between lens portions, each lens portion including a through-the-lens (TTL) loupe;
providing a nosepiece component configured for coupling to the bridge portion of the eyeglass frames;
providing a plurality of spacer components, each with a different thickness;
placing the eyeglass frames on a wearer, and observing the distance between the TTL loupes and facial features of the wearer; and
installing one or more of the spacer components between the nosepiece component and the bridge portion of the eyeglass frames to achieve a desired distance between the TTL loupes and facial features of the wearer.

15. The method of claim 14, wherein:
nosepiece component is an inverted-V shape comprising two angled leg portions formed with a flexible material over a bendable wire frame or scaffold; and
including the step of bending the leg portions to achieve a desired fit of the nosepiece component.

16. The method of claim 14, wherein the spacer components facilitate adjustment of the distance in a range of 1 mm to 1.5 cm or more.
